(19) United States
(12) Patent Application Publication
(10) Pub. No.: US 2015/0095147 A1
(43) Pub. Date: Apr. 2, 2015

(54) MONETIZING QUALIFIED LEADS

(71) Applicant: Grant Samuel Bryce, Cremorne (AU)

(72) Inventor: Grant Samuel Bryce, Cremorne (AU)

(21) Appl. No.: 14/318,626

(22) Filed: Jun. 28, 2014

Related U.S. Application Data
(60) Provisional application No. 61/884,851, filed on Sep. 30, 2013.

(51) Int. Cl. G06Q 30/02

(52) U.S. Cl. CPC G06Q 30/0255
USPC 705/14.53

(57) ABSTRACT

A system and method of monetizing qualified leads are disclosed. A plurality of potential buyers for an item being offered for sale by a seller can be determined based on at least one indication of interest in the item for each one of the potential buyers. The potential buyers are determined from amongst users of an e-commerce site. A featured ad for the item can be caused to be provided selectively to the potential buyers based on a selection by the seller to provide the featured ad to users of the e-commerce site that have been determined to be potential buyers. The indication(s) of interest in the item can comprise an indication of the corresponding potential buyer saving the item to a list of items to watch and/or an indication of the corresponding potential buyer saving a search query of which the item was included as a search result.

### CROSS-REFERENCE TO RELATED APPLICATIONS

The application claims priority to U.S. Provisional Application No. 61/884,851, filed on Sep. 30, 2013, entitled, “MONETIZING QUALIFIED LEADS,” which is hereby incorporated by reference in its entirety as if set forth herein.

### TECHNICAL FIELD

The present application relates generally to the technical field of data processing, and, in various embodiments, to systems and methods of monetizing qualified leads.

### BACKGROUND

For an e-commerce seller of an item, there are limited opportunities, if any, to engage with a potential buyer to proactively upsell the item prior to the potential buyer taking a step to engage the seller.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating components of a qualified leads monetizing system, in accordance with some embodiments;

FIG. 5 is a flowchart illustrating a method of monetizing qualified leads, in accordance with some embodiments;

FIG. 6 is a flowchart illustrating another method of monetizing qualified leads, in accordance with some embodiments;

FIG. 7 illustrates a graphical user interface in which an option of sending a featured ad to potential buyers is provided, in accordance with some embodiments;

FIG. 8 illustrates another graphical user interface in which an option of sending a featured ad to potential buyers is provided, in accordance with some embodiments;

FIG. 9 illustrates an e-mail message in which an option of sending a featured ad to potential buyers is provided, in accordance with some embodiments;

FIG. 10 illustrates an e-mail message in which a featured ad is provided to a potential buyer, in accordance with some embodiments;

FIG. 11 is a block diagram illustrating a mobile device, in accordance with some example embodiments; and

FIG. 12 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of monetizing qualified leads. By providing the functionality for sellers to directly feature their ads to potential buyers that have expressed an interest in their ad (e.g., via saving an ad to a watchlist or saving a search that an ad falls within), the sellers' chances of selling their items can be increased. This feature leverages knowledge about the types of ads that potential buyers may be looking for, and then enables sellers to proactively reach out to the potential buyers of their item through a featured ad alert. This feature can be monetized and be added to a pool of seller-focused paid features.

In some embodiments, a plurality of potential buyers for an item being offered for sale by a seller can be determined based on at least one indication of interest in the item for each one of the potential buyers in the plurality of potential buyers. The plurality of potential buyers can be determined from amongst users of an e-commerce site. A featured ad for the item can be caused to be provided selectively to the potential buyers based on a selection by the seller to provide the featured ad to users of the e-commerce site that have been determined to be potential buyers.

In some embodiments, the indication(s) of interest in the item comprises an indication of the corresponding potential buyer saving the item to a list of items to watch. In some embodiments, the indication(s) of interest in the item comprises an indication of the corresponding potential buyer saving a search query of which the item was included as a search result.

In some embodiments, subsequent to determining the plurality of potential buyers, the seller can be provided with an option of sending the featured ad to the determined plurality of potential buyers, and, subsequent to determining the plurality of potential buyers, the selection by the seller can be received. The selection can comprise a request to provide the featured ad to the determined plurality of potential buyers. In some embodiments, the providing the seller with the option is based on a determination that the determined plurality of potential buyers comprises a number of users that meets a predetermined minimum threshold number of users. In some embodiments, a quantity of the plurality of potential buyers is determined, and, subsequent to determining the plurality of potential buyers and prior to receiving the selection by the seller, the quantity of the plurality of potential buyers is provided to the seller.

In some embodiments, prior to determining the plurality of potential buyers, the seller is provided with an option of sending the featured ad to users that will be determined to be potential buyers based on the indication(s) of interest in the item, and, prior to determining the plurality of potential buyers, the selection by the seller is received. The selection can comprise a request to provide the featured ad to users that will be determined to be potential buyers based on the indication(s) of interest in the item. In some embodiments, the causing of the featured ad for the item to be provided selectively to the potential buyers is performed automatically in response to a determination that the determined plurality of potential buyers comprises a number of users that meets a predetermined minimum threshold number of users.

In some embodiments, causing the featured ad for the item to be provided selectively to the potential buyers comprises causing the featured ad to be displayed on a corresponding computing device of each one of the plurality of potential buyers. In some embodiments, causing the featured ad to be displayed comprises at least one of causing the featured ad to be displayed on a page of a website, causing the featured ad to be displayed on a page of a mobile application, sending an e-mail message including the featured ad, and sending a text message including the featured ad.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

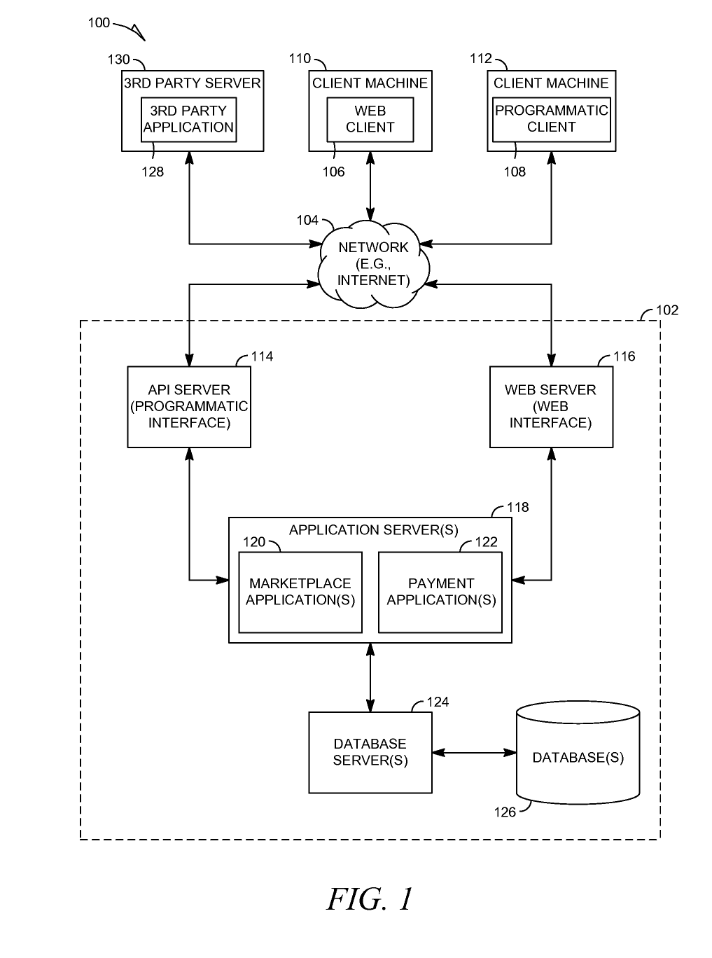

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

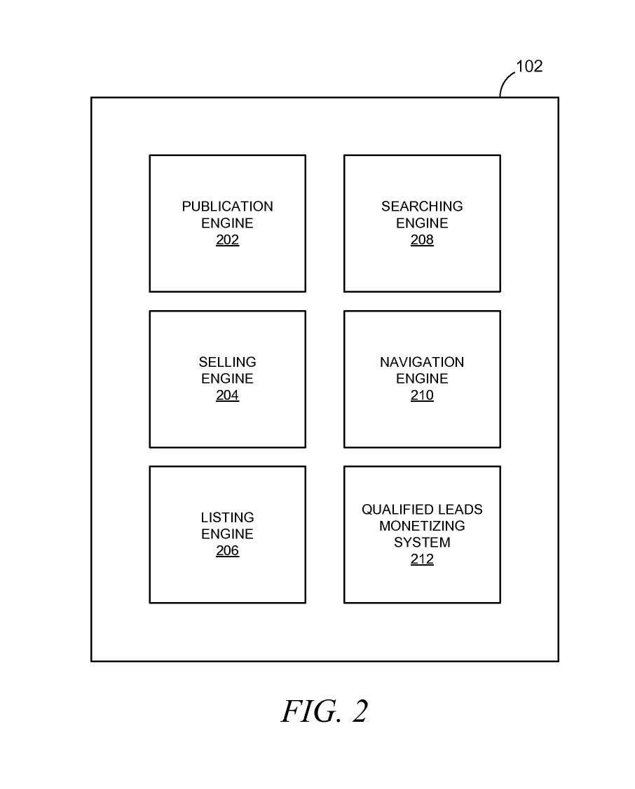

FIG. 2 illustrates a block diagram showing components provided within the networked system 102 according to some embodiments. The networked system 102 may be hosted on dedicated or shared server machines (not shown) that are communicatively coupled to enable communications between server machines. The components themselves are communicatively coupled (e.g., via appropriate interfaces) to each other and to various data sources, so as to allow information to be passed between the applications or so as to allow the applications to share and access common data. Furthermore, the components may access one or more databases 126 via the database servers 124.

The networked system 102 may provide a number of publishing, listing, and/or price-setting mechanisms whereby a seller (also referred to as a first user) may list (or publish information concerning) goods or services for sale or barter, a buyer (also referred to as a second user) can express interest in or indicate a desire to purchase or barter such goods or services, and a transaction (such as a trade) may be completed pertaining to the goods or services. To this end, the networked system 102 may comprise at least one publication engine 202 and one or more selling engines 204. The publication engine 202 may publish information, such as item listings or product description pages, on the networked system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding. The selling engines 204 may further comprise one or more deal engines that support merchant-generated offers for products and services.

A listing engine 206 allows sellers to conveniently author listings of items or authors to author publications. In one embodiment, the listings pertain to goods or services that a user (e.g., a seller) wishes to transact via the networked system 102. In some embodiments, the listings may be an offer, deal, coupon, or discount for the good or service. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the networked system 102 (e.g., databases 126). Listings also may comprise product description pages that display a product and information (e.g., product title, specifications, and reviews) associated with the product. In some embodiments, the product description page may include an aggregation of item listings that correspond to the product described on the product description page.

The listing engine 206 may also allow buyers to conveniently author listings or requests for items desired to be purchased. In some embodiments, the listings may pertain to goods or services that a user (e.g., a buyer) wishes to transact via the networked system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

In some embodiments, the listing engine 206 allows sellers to generate offers for discounts on products or services. The listing engine 206 may receive listing data, such as the product or service being offered, a price and/or discount for the product or service, a time period for which the offer is valid, and so forth. In some embodiments, the listing engine 206 permits sellers to generate offers from the sellers' mobile devices. The generated offers may be uploaded to the networked system 102 for storage and tracking.

Searching the networked system 102 is facilitated by a searching engine 208. For example, the searching engine 208 enables keyword queries of listings published via the networked system 102. In example embodiments, the searching engine 208 receives the keyword queries from a device of a user and conducts a review of the storage device storing the listing information. The review will enable compilation of a result set of listings that may be sorted and returned to the client device (e.g., device machine 110, 112) of the user. The searching engine 208 may record the query (e.g., keywords) and any subsequent user actions and behaviors (e.g., navigations).

The searching engine 208 also may perform a search based on the location of the user. A user may access the searching engine 208 via a mobile device and generate a search query. Using the search query and the user's location, the searching engine 208 may return relevant search results for products, services, offers, auctions, and so forth to the user. The searching engine 208 may identify relevant search results both in a list form and graphically on a map. Selection of a graphical indicator on the map may provide additional details regarding the selected search result. In some embodiments, the user may specify as part of the search query a radius or distance from the user's current location to limit search results.

The searching engine 208 also may perform a search based on an image. The image may be taken from a camera or imaging component of a client device or may be accessed from storage.

In a further example, a navigation engine 210 allows users to navigate through various categories, catalogs, or inventory data structures according to which listings may be classified within the networked system 102. For example, the navigation engine 210 allows a user to successively navigate down a category tree comprising a hierarchy of categories (e.g., the category tree structure) until a particular set of listings is reached. Various other navigation applications within the navigation engine 210 may be provided to supplement the searching and browsing applications. The navigation engine 210 may record the various user actions (e.g., clicks) performed by the user in order to navigate down the category tree.

In some embodiments, a qualified leads monetizing system 212 may be configured to provide functionality for sellers to directly feature their ads to potential buyers that have expressed an interest in their ad. The features, functions, and operations of the qualified leads monetizing system 212 will be discussed in further detail below.

Additional modules and engines associated with the networked system 102 are described below in further detail. It should be appreciated that modules or engines may embody various aspects of the details described below.

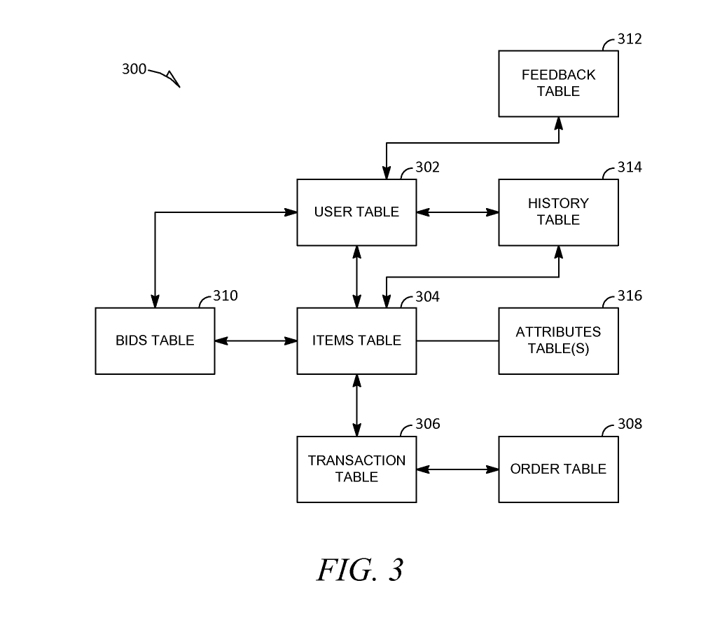

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application. A feedback table 312 is utilized by one or more reputation applications, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, with the currency attribute identifying the currency of a price for the relevant item as specified by a seller.

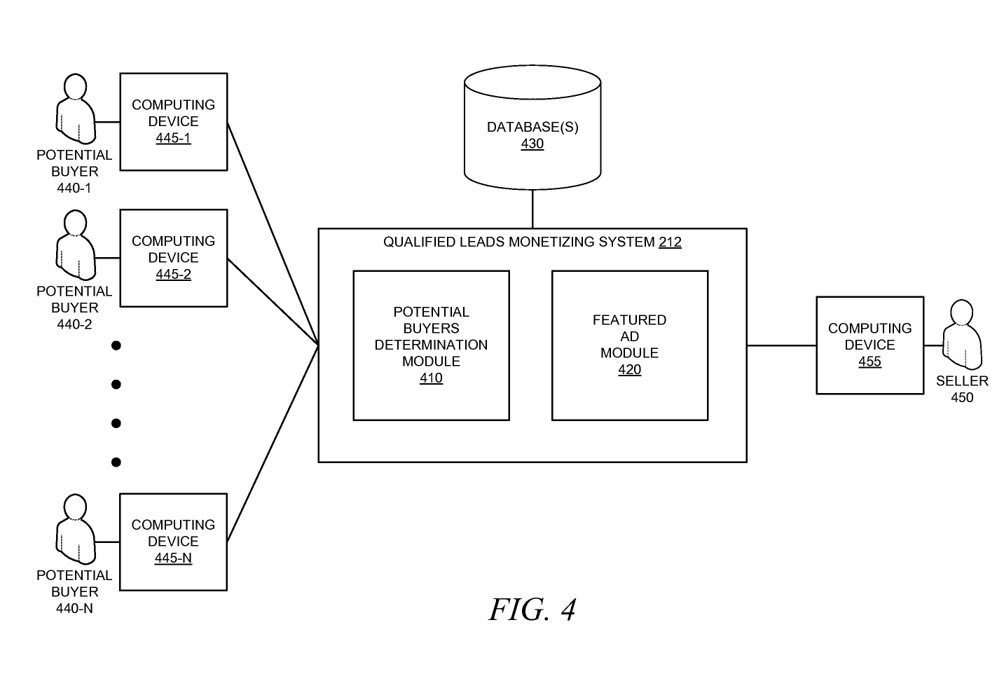

FIG. 4 is a block diagram illustrating components of a qualified leads monetizing system 212, in accordance with some embodiments. In some embodiments, the qualified leads monetizing system 212 comprises a potential buyers determination module 410 and a featured ad module 420.

The potential buyers determination module 410 may be configured to determine potential buyers 440-1, 440-2, . . . , 440-N (collectively referred to as potential buyers 440) for an item being offered for sale by a seller 450. The item can be offered for sale on an online marketplace or classified ad site. The item can also be offered on other types of e-commerce sites as well. In some embodiments, the potential buyers determination module 410 is configured to determine potential buyers for the item based on indications of interest in the item. These indications of interest can include one or more predetermined user actions corresponding to the item. One example of such a user action is a user saving the item to a list of items to watch (e.g., a “watch list”). Another example of such a user action is a user saving a search query of which the item was included as a search result (e.g., a saved search that includes the item as a result). Other types of user actions are also within the scope of the present disclosure. One or more records of these user actions may be stored on one or more databases 430. In some embodiments, database(s) 430 may be incorporated into database(s) 126 in FIG. 1. However, it is contemplated that other configurations are also within the scope of the present disclosure. The potential buyers determination module 410 can determine that certain users are potential buyers 440 based on a determination that user actions of these users qualify as expressing interest in the item. For example, in some embodiments, the potential buyers determination module 410 determines that any user that saves the item in a watch list or creates a saved search that includes the item as a result of the search is a potential buyer. It is contemplated that the other configurations of qualifying criteria for identifying a user as a potential buyer are also within the scope of the present disclosure.

The featured ad module 420 may be configured to provide the seller 450 with an option of sending a featured ad for the item to the potential buyers 440. In some embodiments, the featured ad module 420 is configured to provide this featured ad option to the seller 450 in response to a determination that a predetermined minimum threshold number of potential buyers 440 for the item has been met. For example, the featured ad module 420 can require that at least fifty potential buyers 440 have been found or otherwise determined (e.g., at least fifty users have either saved the item in a watch list or saved a search of which the item was a result) in order for the option of sending a featured ad to the potential buyers 440 to be provided to the seller 450 of the item. Based on the minimum threshold number of potential buyers 440 for an item being met, the option of sending the potential buyers 440 the featured ad for the item can be provided to the seller 450 of the item.

In some alternative embodiments, the featured ad module 420 may be configured to automatically send a featured ad for the item to the potential buyers 440 in response a determination being made that the minimum threshold number of potential buyers 440 has been met. The seller 450 can instruct or configure the featured ad module 420 to take this automatic action in order to have a featured ad that is send as soon as possible without being held up by the seller 450 having to be notified and authorize the sending of the featured ad after the threshold number of potential buyers 440 is met.

In some embodiments, the seller 450 can set or otherwise control the minimum threshold number of potential buyers 440. In some embodiments, an administrator of the qualified leads monetizing system 212 can set or otherwise control the minimum threshold number of potential buyers 440.

Whether the seller 450 is provided the option of sending the featured ad in response to a determination that the minimum threshold number of potential buyers 440 has been met or prior to the determination that the minimum threshold number of potential buyers 440 has been met, this option may provided in a variety of ways. In some embodiments, the featured ad option can be presented to the seller 450 in the form of a tool for sellers as part of or in connection with the e-commerce site on which the item is listed for sale. In some embodiments, the featured ad option can be presented to the seller 450 in the form of an e-mail message. It is contemplated that other configurations and ways of presenting the featured ad option to the seller 450 are also within the scope of the present disclosure.

In some embodiments, the featured ad module 420 can be configured to require that the seller 450 provide payment for sending the featured ad to the potential buyers. The payment for this feature may be carried out and verified in a variety of ways. In some embodiments, this featured ad feature can be presented to the seller 450 along with other seller-oriented features that the seller 450 can select and purchase.

The featured ad can be sent to the potential buyers 440 in a variety of ways. In some embodiments, the featured ad is sent to the potential buyers 440 as part of an e-mail message. In some embodiments, the featured ad can be sent to the potential buyers 440 as part of a text message. In some embodiments, the featured ad can be presented to the potential buyers 440 within a tool for potential buyers as part of or in connection with the e-commerce site on which the item is listed for sale. However, it is contemplated that the featured ad can be sent to the potential buyers 440 in other ways as well.

In some embodiments, the seller 450 can view and make selections for (or otherwise interact with) the featured ad option via a computing device 455. The computing device 455 may comprise a variety of different devices, including, but not limited to, a smartphone, a tablet computer, a laptop, or a desktop computer. It is contemplated that other types of computing devices 455 are also within the scope of the present disclosure.

In some embodiments, the potential buyers 440-1, 440-2, . . . , 440-N can view and make selections for (or otherwise interact with) the featured ad via their respective computing devices 445-1, 445-2, . . . , 445-N (collectively referred to as computing devices 445). The computing devices 445 may comprise a variety of different devices, including, but not limited to, a smartphone, a tablet computer, a laptop, or a desktop computer. It is contemplated that other types of computing devices 445 are also within the scope of the present disclosure.

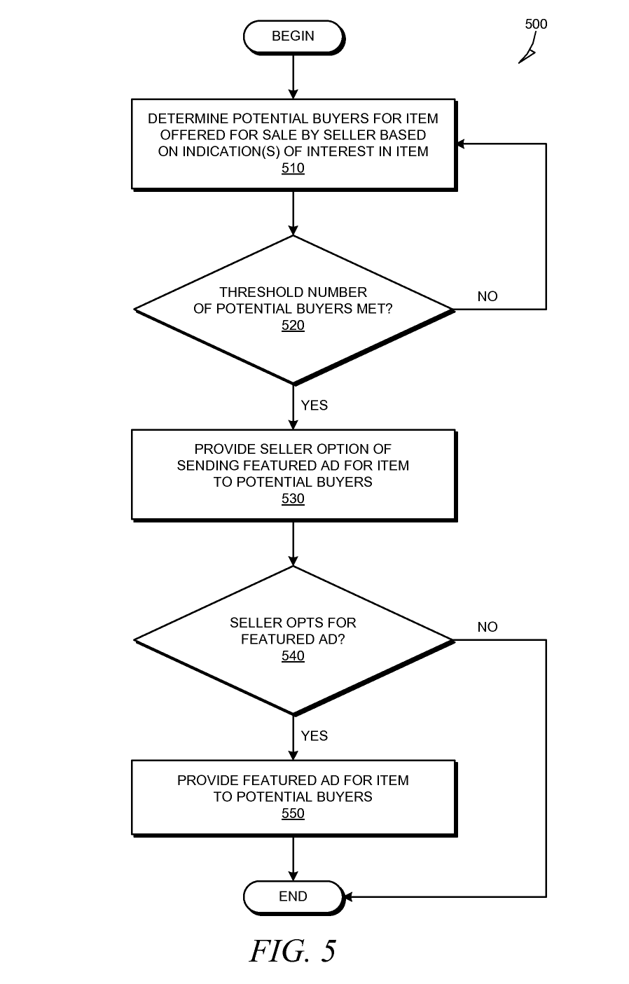

FIG. 5 is a flowchart illustrating a method 500 of monetizing qualified leads, in accordance with some embodiments. The operations of method 500 may be performed by a system or modules of a system (e.g., qualified leads monetizing system 212 or any of its modules).

At operation 510, potential buyers 440 for an item offered for sale by a seller 450 can be determined based on at least one indication of interest in the item for each one of the potential buyers in the plurality of potential buyers. As previously discussed, the item can be offered for sale on an online marketplace or classified ad site. The item can also be offered on other types of e-commerce sites as well. In some embodiments, the indication(s) of interest in the item can include one or more predetermined user actions corresponding to the item. One example of such a user action is a user saving the item to a list of items to watch. Another example of such a user action is a user saving a search query of which the item was included as a search result (e.g., a saved search that includes the item as a result). Other types of user actions are also within the scope of the present disclosure.

At operation 520, it can be determined whether or not a predetermined minimum threshold number of potential buyers 440 has been met (e.g., whether the number of determined potential buyers 440 is equal to or greater than the minimum threshold number of potential buyers 440). In some embodiments, this determination can be made at regular intervals (e.g., once a day). If it is determined that the minimum threshold number of potential buyers 440 has not been met, then the method 500 may return to operation 510, where potential buyers 440 continue to be determined until the minimum threshold number of potential buyers 440 is met.

If it is determined that the minimum threshold number of potential buyers 440 has been met, then, at operation 530, the seller 450 can be provided with an option of sending a featured ad for the item to the potential buyers 440. As previously discussed, the featured ad option may be provided in a variety of ways. In some embodiments, the featured ad option can be presented to the seller 450 in the form of a tool for sellers as part of or in connection with the e-commerce site on which the item is listed for sale. In some embodiments, the featured ad option can be presented to the seller 450 in the form of an e-mail message. It is contemplated that other configurations and ways of presenting the featured ad option to the seller 450 are also within the scope of the present disclosure.

At operation 540, it is determined whether or not the seller 450 has opted for sending a featured ad for the item to the potential buyers 440. If it is determined that the seller 450 has not opted for sending the featured ad to the potential buyers 440, then the method 500 can come to an end.

If it is determined that the seller 450 has opted for sending the featured ad tot the potential buyers 440, then, at operation 550, the featured ad for the item can be provided to the potential buyers 440. As previously discussed, the featured ad can be provided to the potential buyers 440 in a variety of ways. In some embodiments, the featured ad is sent to the potential buyers 440 as part of an e-mail message. In some embodiments, the featured ad can be sent to the potential buyers 440 as part of a text message. In some embodiments, the featured ad can be presented to the potential buyers 440 within a tool for potential buyers as part of or in connection with the e-commerce site on which the item is listed for sale. However, it is contemplated that the featured ad can be provided to the potential buyers 440 in other ways as well.

It is contemplated that the operations of method 500 may incorporate any of the other features disclosed herein.

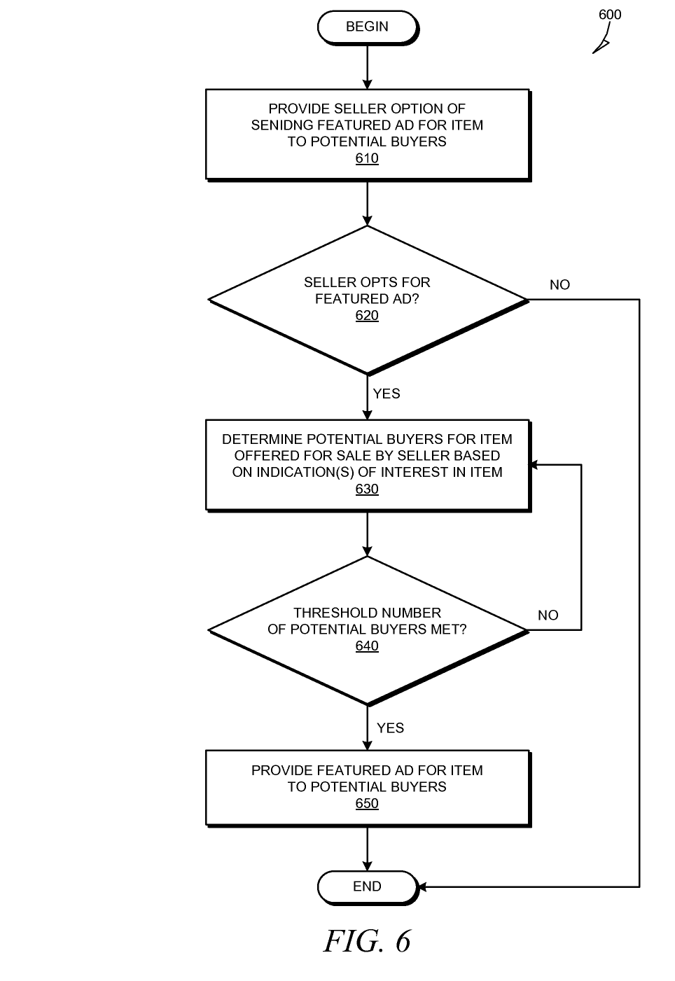

FIG. 6 is a flowchart illustrating another method 600 of monetizing qualified leads, in accordance with some embodiments. The operations of method 600 may be performed by a system or modules of a system (e.g., qualified leads monetizing system 212 or any of its modules).

At operation 610, the seller 450 can be provided with an option of sending a featured ad for the item to the potential buyers 440. As previously discussed, the featured ad option may be provided in a variety of ways. In some embodiments, the featured ad option can be presented to the seller 450 in the form of a tool for sellers as part of or in connection with the e-commerce site on which the item is listed for sale. In some embodiments, the featured ad option can be presented to the seller 450 in the form of an e-mail message. It is contemplated that other configurations and ways of presenting the featured ad option to the seller 450 are also within the scope of the present disclosure.

At operation 620, it is determined whether or not the seller 450 has opted for sending a featured ad for the item to the potential buyers 440. If it is determined that the seller 450 has not opted for sending the featured ad to the potential buyers 440, then the method 600 can come to an end.

If it is determined that the seller 450 has opted for sending the featured ad tot the potential buyers 440, then, at operation 630, potential buyers 440 for the item offered for sale by the seller 450 can be determined based on at least one indication of interest in the item for each one of the potential buyers in the plurality of potential buyers. As previously discussed, the item can be offered for sale on an online marketplace or classified ad site. The item can also be offered on other types of e-commerce sites as well. In some embodiments, the indication(s) of interest in the item can include one or more predetermined user actions corresponding to the item. One example of such a user action is a user saving the item to a list of items to watch. Another example of such a user action is a user saving a search query of which the item was included as a search result (e.g., a saved search that includes the item as a result). Other types of user actions are also within the scope of the present disclosure.

At operation 640, it can be determined whether or not a predetermined minimum threshold number of potential buyers 440 has been met (e.g., whether the number of determined potential buyers 440 is equal to or greater than the minimum threshold number of potential buyers 440). In some embodiments, this determination can be made at regular intervals (e.g., once a day). If it is determined that the minimum threshold number of potential buyers 440 has not been met, then the method 600 may return to operation 630, where potential buyers 440 continue to be determined until the minimum threshold number of potential buyers 440 is met.

If it is determined that the minimum threshold number of potential buyers 440 has been met, then, at operation 650, the featured ad for the item can be provided to the potential buyers 440. As previously discussed, the featured ad can be provided to the potential buyers 440 in a variety of ways. In some embodiments, the featured ad is sent to the potential buyers 440 as part of an e-mail message. In some embodiments, the featured ad can be sent to the potential buyers 440 as part of a text message. In some embodiments, the featured ad can be presented to the potential buyers 440 within a tool for potential buyers as part of or in connection with the e-commerce site on which the item is listed for sale. However, it is contemplated that the featured ad can be provided to the potential buyers 440 in other ways as well.

It is contemplated that the operations of method 600 may incorporate any of the other features disclosed herein.

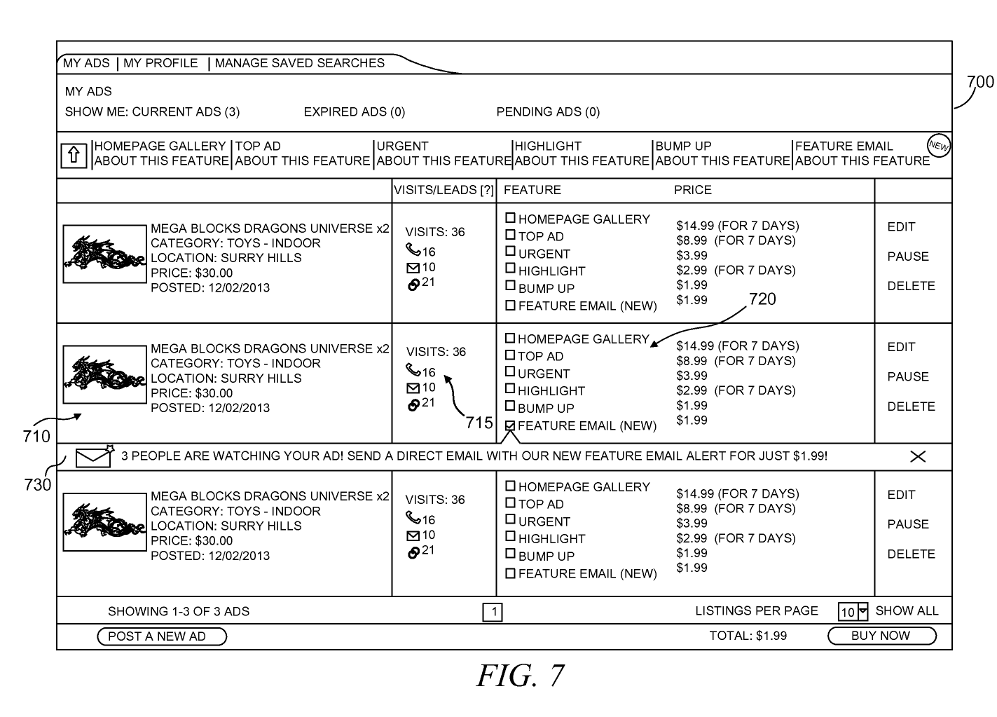

FIG. 7 illustrates a graphical user interface 700 in which an option 730 of sending a featured ad to potential buyers 440 is provided, in accordance with some embodiments. Here, the featured ad option 730 is presented to the seller 450 in the form of a tool for sellers as part of or in connection with the e-commerce site on which the item is listed for sale. In this tool for the sellers, summaries 710 of item ads of the seller 450 can be provided. For example, the tool may provide the seller 450 with a list of each item for which the seller 450 currently has advertised/listed for sale on the e-commerce site. The list may comprise identifying information of the item, including, but not limited to, an identifying image of the item, a name of the item, a description of the item, and a price for the item. The list may also comprise information 715 regarding user activity involving the item, including, but not limited to, how many users have viewed the item ad. It is contemplated that other information can be provided as well. The featured ad option 730 can provide a notification of how many potential buyers 440 there are for the item (e.g., “3 people are watching your Ad!”). In some embodiments, this featured ad option 730 can be presented to the seller 450 along with other seller-oriented features 720 that the seller 450 can select and purchase for the item. Other configurations are also within the scope of the present disclosure.

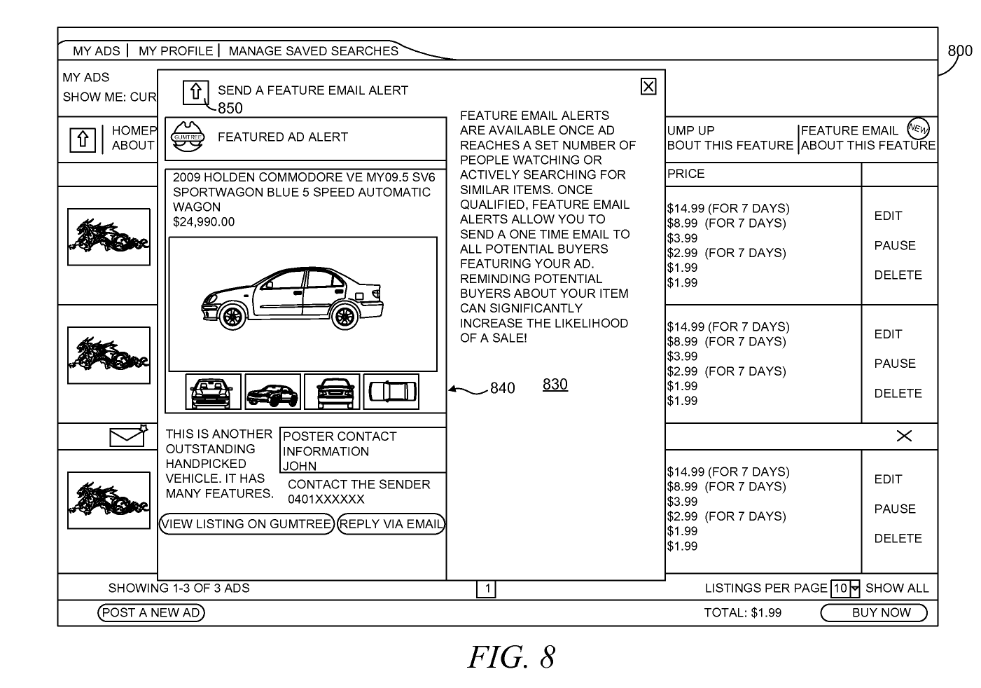

FIG. 8 illustrates another graphical user interface 800 in which an option 830 of sending a featured ad to potential buyers is provided, in accordance with some embodiments. Similar to the featured ad option 730 in FIG. 7, the featured ad option 830 can be presented to the seller 450 in the form of a tool for sellers as part of or in connection with the e-commerce site on which the item is listed for sale. However, in FIG. 8, the featured ad option 830 is presented in the form of a dedicated overlay. In some embodiments, the featured ad option 830 can display a preview 840 to the seller 450 of what the featured ad will look like when it is displayed to the potential buyers 440. A selectable user interface element 850 (e.g., a selectable button) can be provided as part of the featured ad option 830 in order to enable the seller 450 to proceed with the selection of the featured ad. Other configurations are also within the scope of the present disclosure.

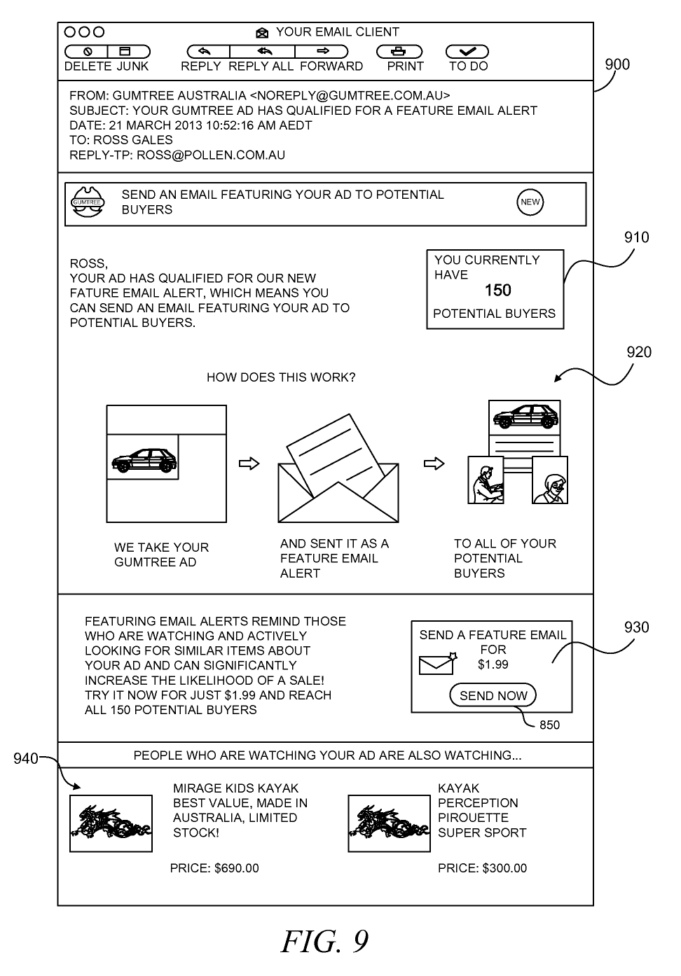

FIG. 9 illustrates an e-mail message 900 in which an option 930 of sending a featured ad to potential buyers is provided, in accordance with some embodiments. The e-mail message 900 can provide a notification 910 of how many potential buyers 440 there are for the item (e.g., “You currently have 150 potential buyers”). The e-mail message 900 can also comprise information 920 about how the featured ad feature works. A selectable user interface element 950 (e.g., a selectable button) can be provided as part of the featured ad option 930 in order to enable the seller 450 to proceed with the selection of the featured ad. In some embodiments, the e-mail message 900 can also include a notification 940 about what items people who are watching the seller's item are also watching. Other configurations are also within the scope of the present disclosure.

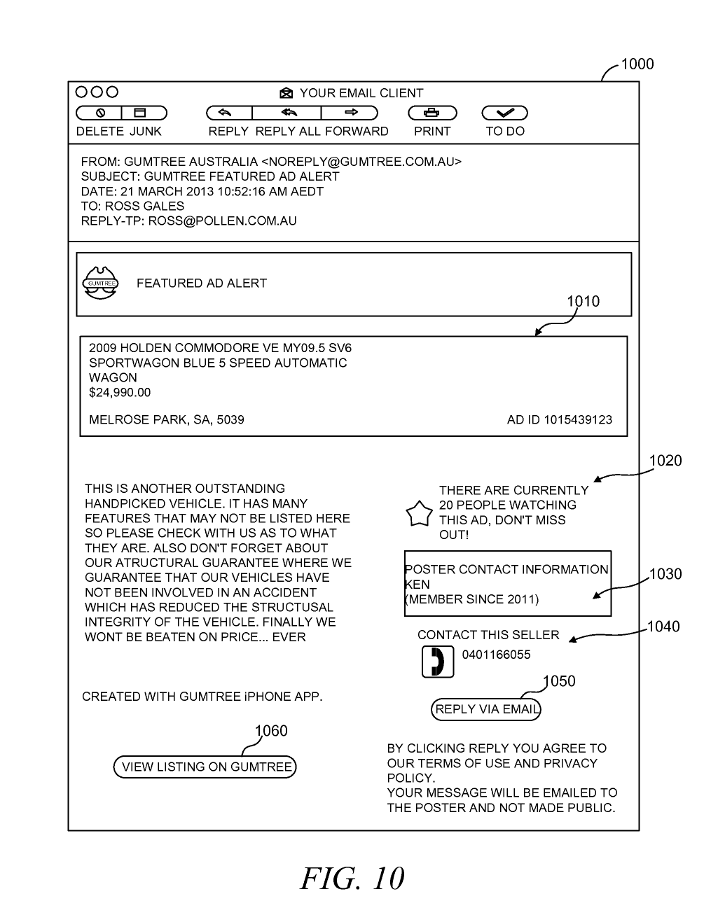

FIG. 10 illustrates an e-mail message 1000 in which a featured ad is provided to a potential buyer, in accordance with some embodiments. The featured ad can include information 1010 about the item being advertised, including, but not limited to, a title or name of the item, a price of the item, a description of the item, and a location associated with the item. The featured ad can also include an identification number for the item ad, which the recipient of the featured ad can use to identify and view the item ad via the e-commerce site outside the context of the e-mail message 1000. The featured ad can further include a notification 1020 of how many people are currently watching the item being offered for sale by the seller 450. The featured ad can also include contact information 1030 of the seller 450, as well as selectable user interface elements 1040 and 1050 to enable the recipient of the e-mail message 1000 to contact the seller 450, such as by phone using the selectable user interface element 1040 or by e-mail using the selectable user interface element 1050. A selectable interface element 1060 (e.g., a selectable link) may also be provided to enable the user to view the listing for the item on the e-commerce site.

It is contemplated that the featured ad can be provided to a potential buyer in a variety of ways other than an e-mail message, including, but not limited to, on a page of a website that the potential buyer visits, on a page of a mobile application that the potential buyer views on a mobile device, and included in a text message that the potential buyer receives. Other ways of providing the featured ad to a potential buyer are also within the scope of the present disclosure.

It is contemplated that any features of any embodiments disclosed herein can be combined with any other features of any other embodiments disclosed herein. Accordingly, these any such hybrid embodiments are within the scope of the present disclosure.

### Example Mobile Device

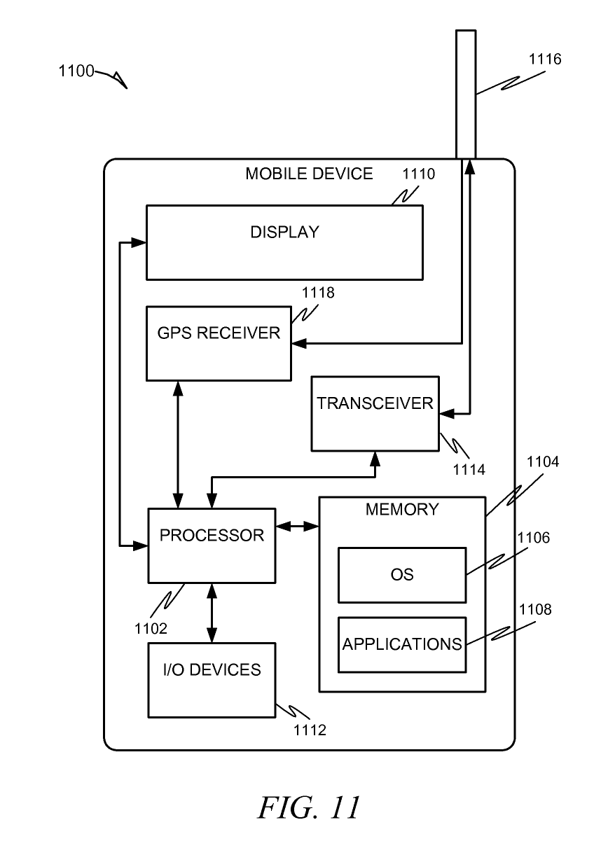

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location enabled application that can provide LBSs to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

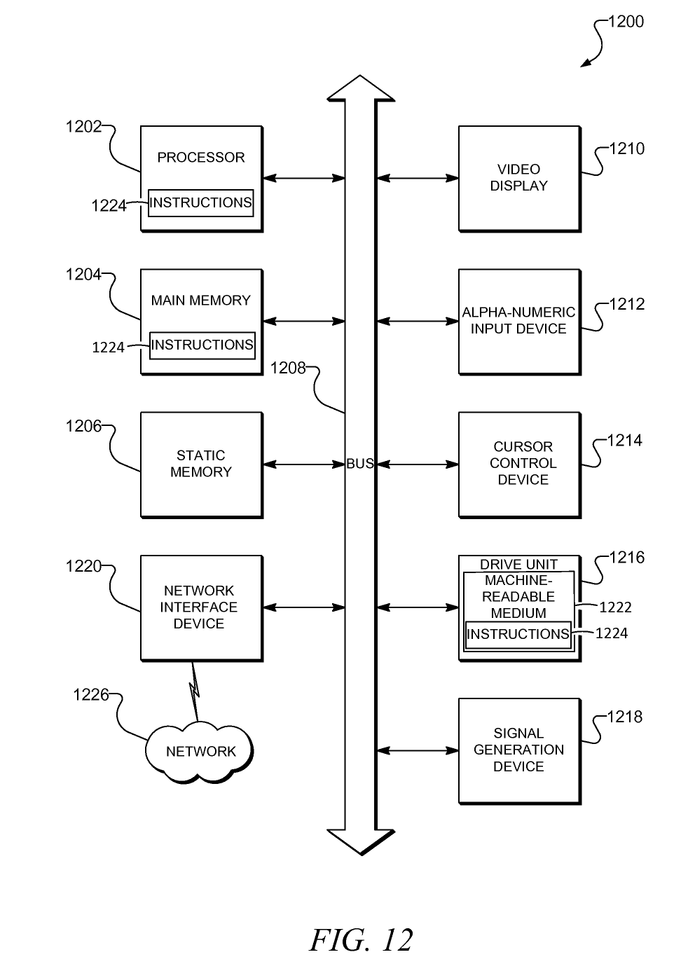

FIG. 12 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse), a disk drive unit 1216, a signal generation device 1218 (e.g., a speaker), and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
determining, by a machine having a memory and at least one processor, a plurality of potential buyers for an item being offered for sale by a seller based on at least one indication of interest in the item for each one of the potential buyers in the plurality of potential buyers, the plurality of potential buyers being determined from amongst users of an e-commerce site; and
causing a featured ad for the item to be provided selectively to the potential buyers based on a selection by the seller to provide the featured ad to users of the e-commerce site that have been determined to be potential buyers.

2. The method of claim 1, wherein the at least one indication of interest in the item comprises an indication of the corresponding potential buyer saving the item to a list of items to watch.

3. The method of claim 1, wherein the at least one indication of interest in the item comprises an indication of the corresponding potential buyer saving a search query of which the item was included as a search result.

4. The method of claim 1, further comprising:
providing, subsequent to determining the plurality of potential buyers, the seller with an option of sending the featured ad to the determined plurality of potential buyers; and
receiving, subsequent to determining the plurality of potential buyers, the selection by the seller, the selection comprising a request to provide the featured ad to the determined plurality of potential buyers.

5. The method of claim 4, wherein the providing the seller with the option is based on a determination that the determined plurality of potential buyers comprises a number of users that meets a predetermined minimum threshold number of users.

6. The method of claim 5, further comprising:
determining a quantity of the plurality of potential buyers; and
providing, subsequent to determining the plurality of potential buyers and prior to receiving the selection by the seller, the quantity of the plurality of potential buyers to the seller.

7. The method of claim 1, further comprising:
providing, prior to determining the plurality of potential buyers, the seller with an option of sending the featured ad to users that will be determined to be potential buyers based on the at least one indication of interest in the item; and
receiving, prior to determining the plurality of potential buyers, the selection by the seller, the selection comprising a request to provide the featured ad to users that will be determined to be potential buyers based on the at least one indication of interest in the item.

8. The method of claim 7, wherein the causing of the featured ad for the item to be provided selectively to the potential buyers is performed automatically in response to a determination that the determined plurality of potential buyers comprises a number of users that meets a predetermined minimum threshold number of users.

9. The method of claim 1, wherein causing the featured ad for the item to be provided selectively to the potential buyers comprises causing the featured ad to be displayed on a corresponding computing device of each one of the plurality of potential buyers.

10. The method of claim 9, wherein causing the featured ad to be displayed comprises at least one of causing the featured ad to be displayed on a page of a website, causing the featured ad to be displayed on a page of a mobile application, sending an e-mail message including the featured ad, and sending a text message including the featured ad.

11. A system comprising:
a machine having a memory and at least one processor; and
at least one module, executable by the at least one processor, configured to:
determine a plurality of potential buyers for an item being offered for sale by a seller based on at least one indication of interest in the item for each one of the potential buyers in the plurality of potential buyers, the plurality of potential buyers being determined from amongst users of an e-commerce site; and
cause a featured ad for the item to be provided selectively to the potential buyers based on a selection by the seller to provide the featured ad to users of the e-commerce site that have been determined to be potential buyers.

12. The system of claim 11, wherein the at least one indication of interest in the item comprises at least one of an indication of the corresponding potential buyer saving the item to a list of items to watch and an indication of the corresponding potential buyer saving a search query of which the item was included as a search result.

13. The system of claim 11, wherein the at least one module is further configured to:
provide, subsequent to determining the plurality of potential buyers, the seller with an option of sending the featured ad to the determined plurality of potential buyers; and
receive, subsequent to determining the plurality of potential buyers, the selection by the seller, the selection comprising a request to provide the featured ad to the determined plurality of potential buyers.

14. The system of claim 13, wherein the providing the seller with the option is based on a determination that the determined plurality of potential buyers comprises a number of users that meets a predetermined minimum threshold number of users.

15. The system of claim 14, wherein the at least one module is further configured to:
determine a quantity of the plurality of potential buyers; and
provide, subsequent to determining the plurality of potential buyers and prior to receiving the selection by the seller, the quantity of the plurality of potential buyers to the seller.

16. The system of claim 11, wherein the at least one module is further configured to:
provide, prior to determining the plurality of potential buyers, the seller with an option of sending the featured ad to users that will be determined to be potential buyers based on the at least one indication of interest in the item; and
receive, prior to determining the plurality of potential buyers, the selection by the seller, the selection comprising a request to provide the featured ad to users that will be determined to be potential buyers based on the at least one indication of interest in the item.

17. The system of claim 16, wherein the causing of the featured ad for the item to be provided selectively to the potential buyers is performed automatically in response to a determination that the determined plurality of potential buyers comprises a number of users that meets a predetermined minimum threshold number of users.

18. The system of claim 11, wherein causing the featured ad for the item to be provided selectively to the potential buyers comprises causing the featured ad to be displayed on a corresponding computing device of each one of the plurality of potential buyers.

19. The system of claim 18, wherein causing the featured ad to be displayed comprises at least one of causing the featured ad to be displayed on a page of a website, causing the featured ad to be displayed on a page of a mobile application, sending an e-mail message including the featured ad, and sending a text message including the featured ad.

20. A non-transitory machine-readable storage device storing a set of instructions that, when executed by at least one processor, causes the at least one processor to perform a set of operations comprising:
determining a plurality of potential buyers for an item being offered for sale by a seller based on at least one indication of interest in the item for each one of the potential buyers in the plurality of potential buyers, the plurality of potential buyers being determined from amongst users of an e-commerce site; and
causing a featured ad for the item to be provided selectively to the potential buyers based on a selection by the seller to provide the featured ad to users of the e-commerce site that have been determined to be potential buyers.
